(19) United States
(12) Patent Application Publication
(10) Pub. No.: US 2004/0247310 A1
(43) Pub. Date: Dec. 9, 2004

(54) Method of concealing image information in digital camera and digital camera capable of image information concealment

(75) Inventors: Yong-gi Kim, Seongnam-si (KR); Seon-mi Lee, Seongnam-si (KR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Samsung Techwin Co., Ltd, Changwon-city (KR)

(21) Appl. No.: 10/804,533

(22) Filed: Mar. 19, 2004

(30) Foreign Application Priority Data
Mar. 21, 2003 (KR) 2003-17743

(51) Int. Cl. G03B 13/02

(52) U.S. Cl. 396/374

(57) ABSTRACT

A method of concealing image information in a digital camera includes determining whether to conceal image information during photographing an image using the digital camera, assigning a password to an image to be concealed, setting concealment, photographing an image, digitalizing the photographed image, and storing the digitalized image on a memory card, and not displaying the image set to be concealed on a display window in a reproduction mode.

### BACKGROUND OF THE INVENTION

This application claims the priority of Korean Patent Application No. 2003-17743, filed on Mar. 21, 2003, in the Korean Intellectual Property Office, the disclosure of which is incorporated herein in its entirety by reference.

1. Field of the Invention

The present invention relates to a method of concealing image information in a digital camera and a digital camera capable of image information concealment. More particularly, the present invention relates to a method of concealing image information in a digital camera so that information on a photographed image is not displayed on a display window of the digital camera, and a digital camera capable of concealing image information.

2. Description of the Related Art

Typically, digital cameras reproduce photographed images through display windows installed in the digital cameras. For example, the display window is installed on a rear side of the digital camera and, when a reproduction mode is selected by a user, all photographed images can be displayed through the display window. Meanwhile, the images can be displayed on a computer monitor or a video monitor, not on the display window. When these external devices of the digital camera are used, the external device must be connected to the digital camera through a USB port or a video port.

In a typical digital camera, all photographed images are displayed through the display window regardless of the user's selection. For example, when the user gives a command to reproduce the photographed images on the display window by changing a photographing mode to the reproduction mode, all photographed images are sequentially displayed in the order of photographing, except for the cases in which errors occur during photographing or reproduction or the image file does not match display standards.

FIG. 1 is a flow chart for explaining the steps of photographing and reproduction in a typical digital camera.

Referring to FIG. 1, when a photographing mode is selected in a photographing mode selection step 11, a photographing step 12 is performed. Otherwise, a reproduction mode selection step 15 is performed. In other examples not shown in the drawing, the reproduction mode selection step 15 is not performed and other steps may be performed. When photographing is performed in the photographing step 12, as it is well known, light is separated into RGB color lights by a CCD filter and the RGB color lights are converted to electric signals at a pixel constituted with an optical sensor. The converted electrical signals are converted to digital signals in an image digitalization step 13 and undergo a step 14 of storing the image in a memory card.

Next, a reproduction mode selection step 15 determines whether a previously photographed image is to be reproduced. If the reproduction mode is not selected, the program goes back to the photographing mode selection step 11 and photographing continues to be performed. Thus, practically speaking, the photographing mode continues after the step 14 in which an image digital signal is stored in a memory card. Photographing can be continuously performed unless the user stops photographing and selects the reproduction mode by using a menu selection function of the digital camera.

When the reproduction mode is selected in the reproduction mode selection step 15, a control portion of the camera searches image files stored in the memory card. Next, all searched image files are displayed on the display window (Step 17).

In the photographing and storing steps of the digital camera, among the photographed images there may be an image that the user does not wish to be displayed on the display window. Yet when a third party obtains the digital camera, he/she can display all the stored images by operating the digital camera. Also, there may be instances when the user does not wish to disclose a particular image to others.

However, in the typical digital cameras, since there is no function to selectively conceal a photographed image, all photographed images can be viewed through the display window contrary to the user's intention.

### SUMMARY OF THE INVENTION

To solve the above and/or other problems, the present invention provides a method of concealing image information in a digital camera and a digital camera capable of concealing image information.

According to an aspect of the present invention, a method of concealing image information in a digital camera comprises determining whether to conceal image information during photographing an image using the digital camera, assigning a password to an image to be concealed, setting concealment, photographing an image, digitalizing the photographed image, storing the digitized image on a memory card, and not displaying the image set to be concealed on a display window in a reproduction mode.

The method further comprises, if the concealment setting is not selected in the concealment-setting-determining step, determining whether to conceal the image while viewing the image displayed on the display window in the reproduction mode after photographing, setting concealment for the image selected to be concealed in the concealment-setting-determining step of the reproduction mode, assigning a password, and not displaying the image set to be concealed on the display window.

The method further comprises selecting a concealed-image-view menu to display information on the image that is set to be concealed on the display window, inputting the previously assigned password, searching for the image that has been set to be concealed if the previously assigned password matches the input password, and displaying the located concealed image on the display window.

A user determines whether to set concealment of image information by directly setting an application marker included in an Exif header in an Exif file format for a digital camera.

According to another aspect of the present invention, a method of concealing image information in a digital camera comprises assigning a password for access to an image information concealment setting of the digital camera, determining whether to conceal image information during photographing of an image, setting concealment, photographing an image, digitalizing the photographed image, storing the digitized image on a memory card, and not displaying the image set to be concealed on a display window in a reproduction mode.

The method further comprises, if the concealment setting is not selected in the concealment-setting-determining step, determining whether to conceal the image while viewing the image displayed on the display window in the reproduction mode after photographing, setting concealment to the image set to be concealed in the concealment-setting-determining step of the reproduction mode, and not displaying the image set to be concealed on the display window.

According to another aspect of the present invention, a method of concealing image information in a digital camera comprises assigning a password for an image information concealment setting of the digital camera, determining whether to conceal image information when photographing an image, photographing an image and digitalizing the photographed image, storing the digitized image in a concealment folder on a memory card, and not displaying the image stored in the concealment folder on a display window in a reproduction mode.

The method further comprises, if the concealment setting is not selected in the concealment-setting-determining step, determining whether to conceal the image while viewing the image displayed on the display window in the reproduction mode after photographing, moving the image set to be concealed in the reproduction mode's concealment-setting-determining step to the concealment folder of the memory card and storing the image therein, and not displaying the image stored in the concealment folder of the memory card on the display window.

The method further comprises selecting a concealed-image-view menu to display information on the image that is set to be concealed on the display window, inputting the previously assigned password, searching the concealment folder for the image set to be concealed if the previously assigned password matches the input password, and displaying the searched concealed image on the display window.

According to another aspect of the present invention, a digital camera capable of concealing image information comprises a main body having a lens portion installed at the front surface of the main body, a display portion installed at the rear surface of the main body, a shutter installed at one side of the main body, a concealment setting button installed at one side of the main body so that a user determines whether to set concealment of image information by directly setting an application marker included in an Exif header in an Exif file format for a digital camera, and a password setting button to input a password during concealment setting and reproduction of the concealed image.

According to another aspect of the present invention, a digital camera capable of concealing image information comprises a main body having a lens portion installed at the front surface of the main body, a display portion installed at the rear surface of the main body, a shutter installed at one side of the main body, a concealment setting button installed at one side of the main body to store an image set to be concealed in a concealment folder of a memory card, and a password setting button to input a password during concealment setting and reproduction of the concealed image.

### BRIEF DESCRIPTION OF THE DRAWINGS

The above and other features and advantages of the present invention will become more apparent by describing in detail preferred embodiments thereof with reference to the attached drawings in which:

FIG. 1 is a flow chart for explaining the steps of photographing and reproducing in a typical digital camera;

FIG. 2 is a flow chart for explaining a method of concealing image information in a digital camera according to a first preferred embodiment of the present invention;

FIG. 3 is a flow chart for explaining a method of viewing a concealed file in a reproduction mode;

FIG. 4 is a flow chart for explaining a method of concealing image information in a digital camera according to a second preferred embodiment of the present invention;

FIG. 5 is a flow chart for explaining a method of concealing image information in a digital camera according to a third preferred embodiment of the present invention;

FIG. 6 is a flow chart for explaining a method of viewing a concealed file in a reproduction mode in the third preferred embodiment;

FIG. 7 is a perspective view illustrating a digital camera having a concealment function according to the present invention; and

FIG. 8 is a view illustrating an example of a setting for a password displayed on the display window.

### DETAILED DESCRIPTION OF THE INVENTION

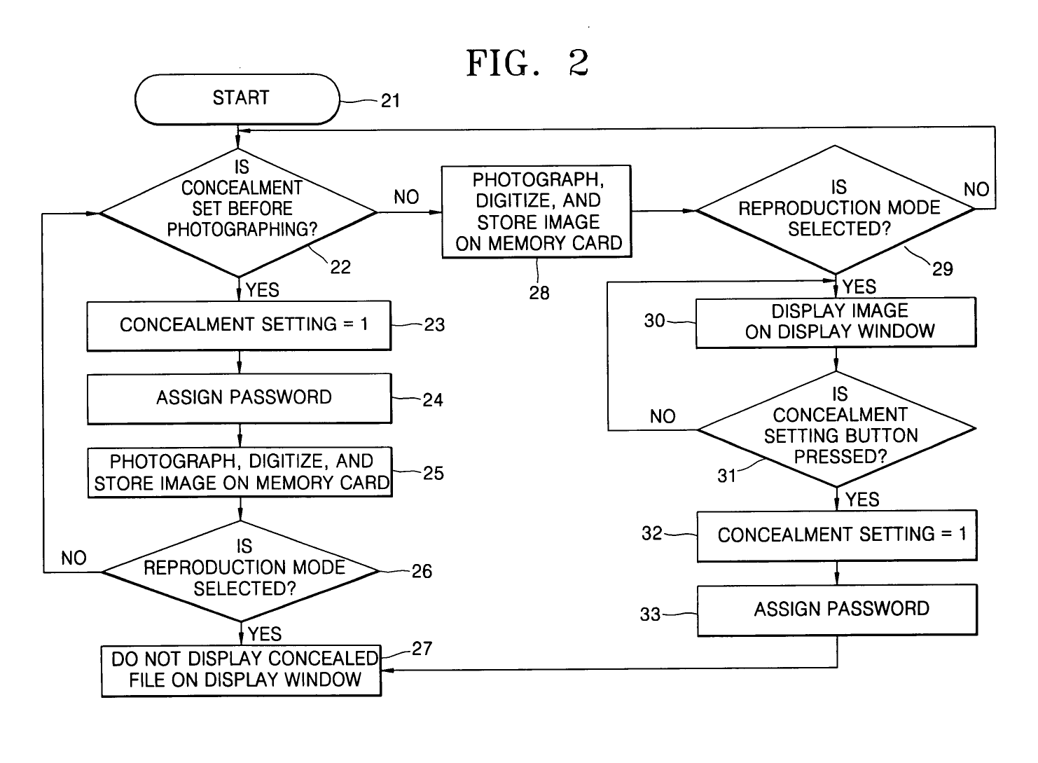

FIG. 2 shows a method of concealing image information in a digital camera according to a first preferred embodiment of the present invention. Referring to FIG. 2, after a digital camera starts to operate (Step 21), it is determined whether information regarding image concealment has been set before the performance of photography (Step 22). If a user wishes to conceal an image, he/she can set image concealment by pressing an image concealment button provided on an external surface of the digital camera, which will be described later. In a concealment setting step (Step 23), concealment can be set as the user directly sets an application marker included in an Exif header of an Exif file format for a digital camera, which will be described in detail below.

Basically, the Exif file format is the same as a JPEG file format to process a digital still image. The Exif file format is formed by adding image/digital camera information data and a thumbnail image to a JPEG file format to correspond to the JPEG file format. Thus, digital camera users can view photographed images through browser programs or viewer programs capable of displaying JPEG images on a computer.

Every JPEG file begins with a binary value “0xFFD8” and ends with a binary value “0xFFD9”. JPEG data include a few binary values of “0xFFXX” data which are referred to as markers signifying a period of JPEG information data. The “0xFFD8” signifies the start of an image (SOI) while the “0xFFD9” signifies the end of an image (EOI). The above two markers do not include data, but other markers include further data. The basic format of the marker is shown below.

0xFF+marker number (1 byte)+data size (2 bytes)+data (n bytes)

The “0xFFE0” through “0xFFEF” used for the marker Exif file format are referred to as “application markers”. These are not needed to decode a JPEG image and are user applications which can be set directly by the user. One of these markers is used as a marker for setting a concealment function so as to assign a tag for setting concealment. That is, in a reproduction mode for displaying a photographed image on a display window, when a tag for a concealment function in the photographed image data is “0”, the photographed image is displayed on the display window, while when the tag is “1”, the photographed image is not displayed. The tag for a concealment function can be input by pressing the concealment setting button provided on the side of the digital camera.

After the concealment setting is performed in the concealment setting step (Step 23), a password is assigned. The password can be arbitrarily set by the user through a number input device, which will be described in detail later, installed on the outer side of the digital camera. When the digital camera is installed on a mobile phone or a PDA, the password can be input through a keyboard provided thereto.

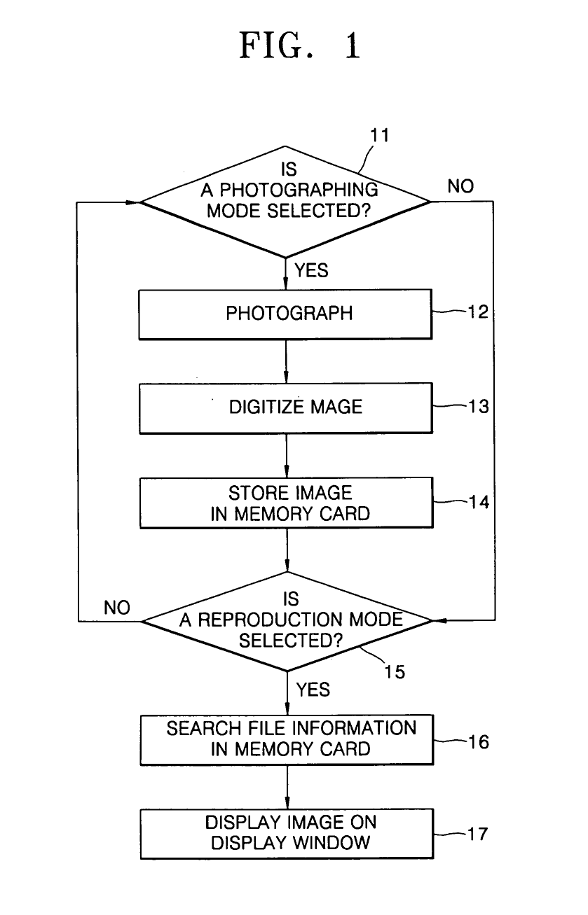

Next, Step 25 is performed, in which an image is photographed by using the digital camera, the photographed image is digitized, and the digitized image is stored on a memory card. Step 25 corresponds to Step 12 through 14 of FIG. 1. When the user selects a reproduction mode through a menu after photographing is performed (Step 26), the photographed image is not displayed on the display window. If the reproduction mode is not selected, the concealment setting can be continuously selected (Step 22) and the photographing, digitalizing, and storing step (Step 25) continues.

In the meantime, in Step 28, the steps of photographing, digitalizing, and storing can be performed, without selecting the concealment setting in Step 22. When a reproduction mode is selected (Step 29), the photographed image is displayed on the display window (Step 30). The concealment setting can be performed while the user sees the display window. That is, if the user seeing the display window wishes to conceal a particular image, he/she sets concealment by pressing the concealment button on the outer side of the digital camera (Step 31) so that the concealment setting is set to “1” (Step 32). Next, a password is assigned (Step 33) and a corresponding image is not displayed on the display window (Step 27).

In the method described with reference to FIG. 2, it can be seen that the concealment setting or password assignment can be performed before photographing or after photographing while viewing images displayed on the display window in the reproduction mode.

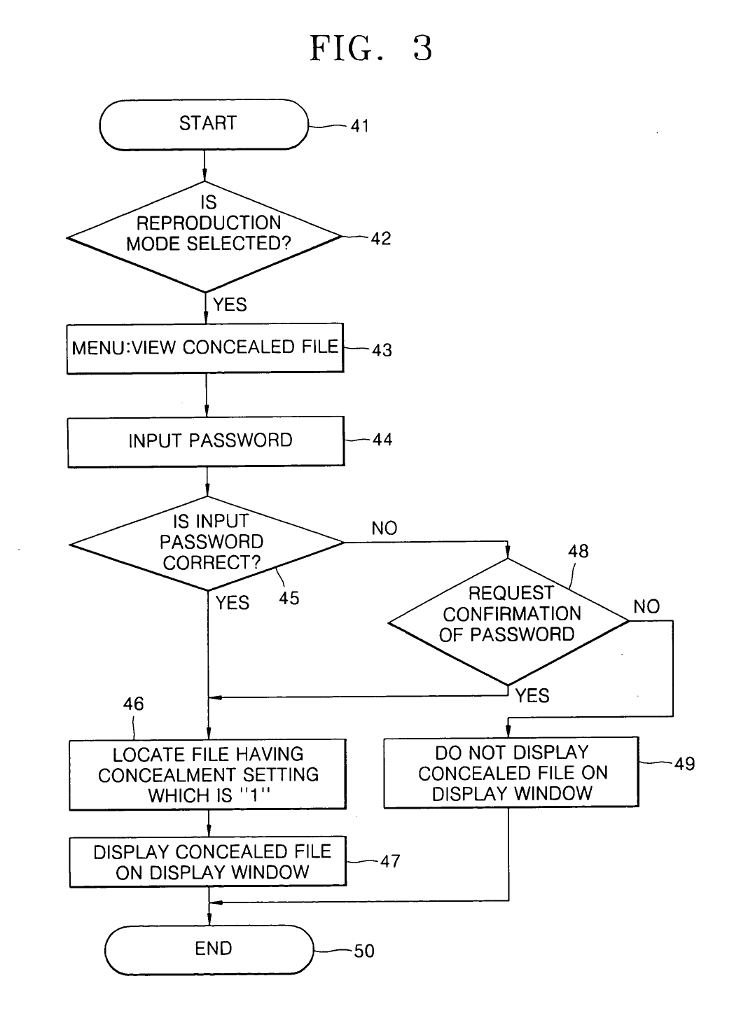

FIG. 3 is a flow chart for explaining a method of viewing a concealed file in a reproduction mode. Referring to FIG. 3, after a start step (Step 41), when reproduction is selected in a reproduction mode selection step (Step 42), a menu item to view a concealed file can be selected (Step 43). When the menu item to view a concealed file is selected, a password is input (Step 44) and it is determined whether the input password is correct (Step 45). When the input password is determined to be correct, the camera searches among the image information files stored on the memory card for an image information file having an application marker for concealment setting which corresponds to “1”, (Step 46). The concealed file is displayed on the display window (Step 47).

If the input password is determined not to be correct in Step 45, confirmation of the password is requested (Step 48). If a correct password is input, a file having the concealment setting of “1” is located (Step 46) and the concealed file is displayed on the display window. However, if a correct password is not input at the request of the confirmation of a password, the concealed file is not displayed (Step 49) and the program ends (Step 50).

In the method shown in FIG. 3, the user selects the concealed file view menu and inputs the previously set password so that the concealed file can be displayed on the display window. The password can be input by using an input button which will be described in detail later.

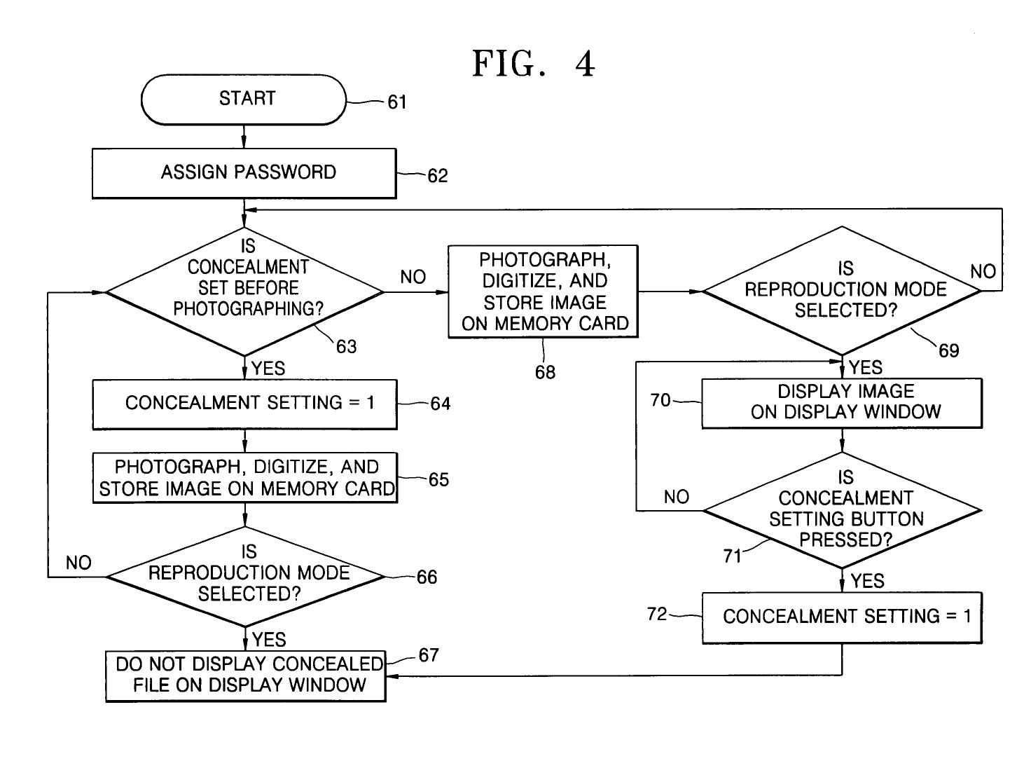

FIG. 4 is a flow chart for explaining a method of concealing image information in a digital camera according to a second preferred embodiment of the present invention. Referring to FIG. 4, after a start step (Step 61), a password is set and input in a password setting step (Step 62). The input of a password can be performed by using an input button which will be described in detail later. Concealment photographing information can be set prior to photographing, and whether the concealment setting is so selected is determined in Step 63. In order to select the concealment setting before performing photography, a user presses a concealment button.

When the concealment button is pressed so that concealment is set before photographing takes place, the application marker described in the above preferred embodiment is set to “1” for the concealment setting. Then, photographing, digitalization of image information, and storing of image information on a memory card are performed (Step 65). Next, when a reproduction mode is selected in a reproduction mode selection step (Step 66), an image set to be concealed is not displayed on the display window (Step 67).

When, in Step 63, concealment is not set prior to photographing, then a step of photographing, digitalization of the photographed image information, and storing the digitized image on the memory card is performed (Step 68). Next, when a reproduction mode is selected in a reproduction mode selection step (Step 69), the stored image information is displayed on the display window (Step 70). The user can determine whether to set image concealment by using the concealment button while viewing the image displayed on the display window (Step 71). When the concealment setting is selected, the application marker for concealment setting is set to “1” (Step 72), as described above. Accordingly, a corresponding image information is not displayed on the display window (Step 67).

In the method shown in FIG. 4, it can be seen that, in the state in which a password is set before photographing, if concealment image information is determined before photographing, the application marker for concealment setting can be set to “1” by pressing the concealment setting button during photographing. Otherwise, the application marker for concealment setting can be set to “1” so as to set concealment by pressing the concealment setting button while viewing a reproduced image in the reproduction mode through the display window. The image information set for concealment can be displayed on the display window through confirmation of a password by using the method of displaying concealed image information that was described with reference to FIG. 3.

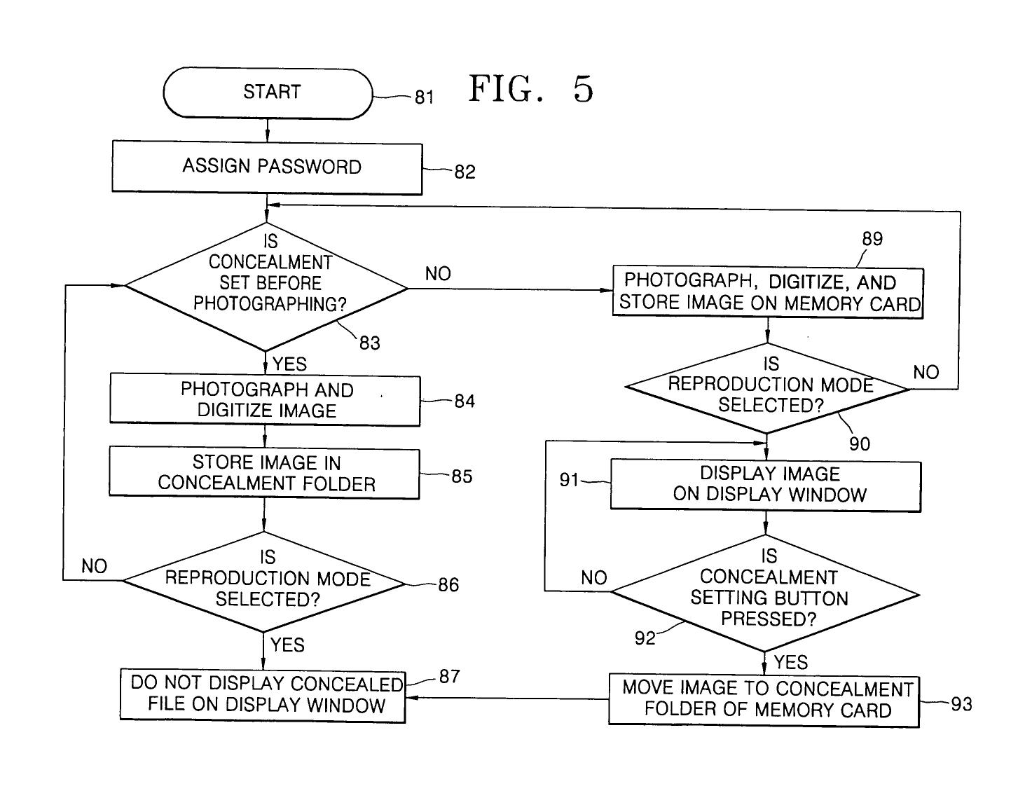

FIG. 5 is a flow chart for explaining a method of concealing image information in a digital camera according to a third preferred embodiment of the present invention. In an example shown in FIG. 5, a method of storing concealed image information in a concealment folder is used, in which an additional concealment folder to contain concealed image information is provided on the memory card. That is, instead of using the above-described application marker, an additional directory is made on the memory card and concealed image information is stored thereon.

Referring to FIG. 5, a password is set (Step 82) after a start step (Step 81). The password is for confirmation when a user accesses the concealed image information stored in the concealment folder. Next, it is determined whether concealment is set before photographing (Step 83). A user sets concealment before photographing by pressing the concealment setting button. Next, photographing is performed and photographed image information is digitized (Step 84). The corresponding image information is stored in the concealment folder on the memory card (Step 85).

Typically, image information photographed by a digital camera is stored in a digital camera file directory according to the design standard of a digital camera file system. File names appropriate to the standard are generated according to the order of photographing and stored in corresponding directories. In the reproduction mode, files appropriate to the corresponding standard are displayed through the display window. Thus, when file names are generated that are not appropriate to the standard and are stored in the additional concealment folder, the image information is concealed, unlike image information files displayed according to the typical standard.

The image information with concealment setting that is stored in the concealment folder of the memory card in Step 85 is not displayed on the display window (Step 87) even when a reproduction mode is selected (Step 86).

When concealment setting is not selected in Step 83 before photographing, photographing is performed without pressing the concealment setting button and the photographed image is digitized and stored on the memory card (Step 89). In this case, the image information stored on the memory card lacks an affirmative concealment setting. When a reproduction mode is selected (Step 90), corresponding image information is displayed on the display window (Step 91). When the user decides to conceal the displayed image information by pressing the concealment button (Step 92), the corresponding image information is moved to the concealment folder of the memory card (Step 93). Thus, the corresponding image information is not displayed on the display window.

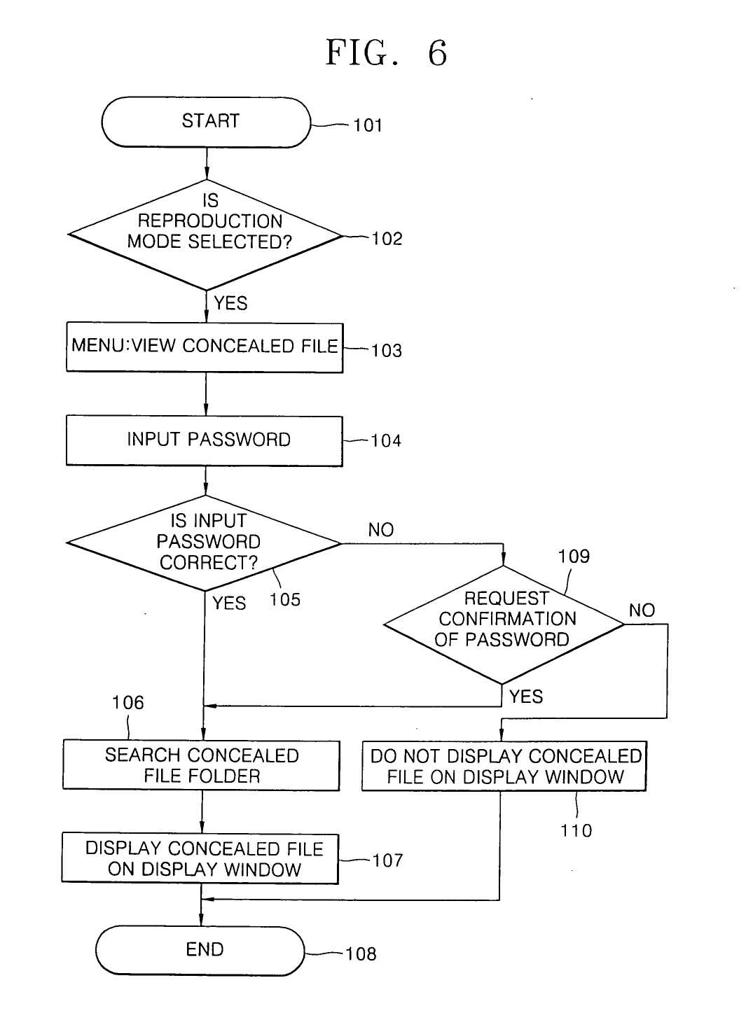

FIG. 6 is a flow chart for explaining a method of viewing a concealed file in a reproduction mode. Referring to FIG. 6, after a start step (Step 101), when reproduction is selected in a reproduction mode selection step (Step 102), a menu item for viewing a concealed file can be selected (Step 103). When the menu item for viewing a concealed file is selected, a password is input (Step 104) and it is determined whether the input password is correct (Step 105). When the input password is determined to be correct, a concealed file folder of the memory card is searched (Step 106). The located concealed file is displayed on the display window (Step 107).

If the input password is determined to be incorrect in Step 105, confirmation of the password is requested (Step 109). If a correct password is input, the concealed file folder is searched (Step 106) and the located concealed file is displayed on the display window (Step 107). However, if a correct password is not input at the request of the confirmation of a password, the concealed file is not displayed (Step 110) and the program ends (Step 108).

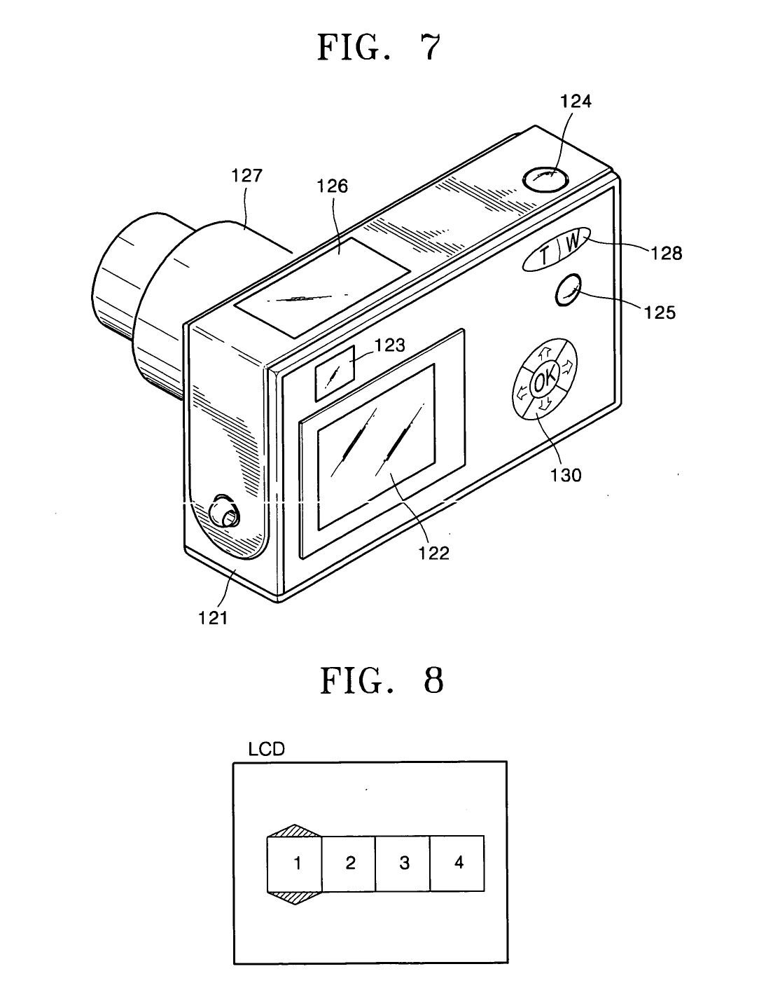

FIG. 7 is a perspective view illustrating a digital camera having a concealment function according to the present invention. Referring to FIG. 7, a digital camera having a concealment function according to the present invention includes a main body 121 and a lens barrel 127 installed on a front surface of the main body 121. A display window 122 is installed on a rear surface of the main body 121 to display photographed images as well as menus and various functions. An information display window 126 can be additionally provided on an upper surface of the main body 121 to display various information required for photographing and reproduction. A viewfinder 123 is provided on one side of the main body 121 so that a user can view an object to be photographed with the naked eye. Photographing is performed by pressing a release button 124. A zoom button 128 is provided on one side of the main body 121 to operate a zoom lens.

According to the characteristic feature of the present invention, a concealment setting button 125 to set concealment of a photographing image is provided on the rear surface of the main body 121. The user can set concealment of a corresponding image information during photographing or reproduction by pressing the concealment setting button 125. A password input button to input a password is provided as a four directional key button 130. The password input button can be realized in a variety of manners. For example, as in the adjustment of time in a typical digital watch, the number increases or decreases as an adjustment button (not shown) is pressed and, when a desired number is displayed, an input button (not shown) is pressed so that a password can be input. In the present preferred embodiment, the four directional key button 130 includes an OK button arranged at the center portion thereof and four arrow buttons arranged around the OK button. The password set by using the four directional key button 130 is displayed on the display window 122.

To input a password, the user selects a password selection item from the menu. Then, a four digit number appear on the display window 122 as shown in FIG. 8. Next, one of the four digits is selected by using the left and right arrow buttons. The number at a selected digit is highlighted compared to other numbers or displayed in different color to show that the number is chosen, i.e., a cursor is moved to a corresponding number. The cursor is moved to one of the four-digit numbers by pressing the left and right arrow buttons and the number is increased or decreased by pressing the up and down arrow buttons. Next, the left and right arrow buttons are used to move the cursor to the next digit. After the user has highlighted various digits by pressing the left and right arrow buttons and selected a desired number for each digit by pressing the up and down arrow buttons, the input of a password is completed by pressing the OK button.

In another example, a wheel button (not shown) can be provided, in which the number increases or decreases by turning the wheel button using a finger and a password is input by pressing the wheel button.

The concealment setting button 125 and the four directional key buttons 130 described with reference to FIG. 7 can be used to perform the method described with reference to FIGS. 2 through 6. For example, in the process described with reference to FIG. 2, in Step 22, photographing is performed after setting concealment by pressing the concealment setting button 125, and in Step 24, a password can be input by pressing the four directional key button 130. Also, in Step 31, concealment setting can be done on an image displayed in a reproduction mode by pressing the concealment setting button 125. In Step 33, a password can be input by using the four directional key button 130.

In FIG. 3, in Step 44, the four directional key button 130 is used to input a password so that image information with concealment setting can be displayed. In FIG. 4, the concealment setting button 125 and the four directional key button 130 can be used in the password setting step (Step 62), the concealment setting step (Step 64), and the concealment setting step (Step 71). The concealment setting button 125 and the four directional key button 130 can be used in the respective steps described with reference to FIGS. 5 through 6.

As described above, according to the present invention, since the user of a digital camera can set concealment to image information before photographing or during reproduction, access by others to the concealed image information can be prevented. Thus, the image information concealment function can contribute to security of personal information and protection of privacy.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method of concealing image information in a digital camera comprising:
determining whether to conceal image information acquired during photographing of an image using the digital camera;
assigning a password to an image to be concealed;
setting concealment to the image to be concealed;
photographing an image;
digitizing the photographed image;
storing the digitized image; and
not displaying the image set to be concealed when the camera is in an image reproduction mode.

2. The method of claim 1, further comprising:
if image concealment is not set before an image is photographed,
determining whether to conceal the image, the determination occurring while the image is displayed in the reproduction mode after photographing;
setting concealment to the image set to be concealed;
assigning a password to the image set to be concealed; and
not displaying the image set to be concealed.

3. The method of claim 2, further comprising:
determining if an option for displaying information on the image set to be concealed has been selected;
allowing a password to be input;
finding the image set to be concealed if the assigned password matches the input password; and
displaying the found concealed image.

4. The method of claim 2, wherein a user determines whether to set concealment of image information by directly setting an application marker included in an Exif header in an Exif file format.

5. The method of claim 1, further comprising:
determining if an option for displaying information on the image set to be concealed has been selected;
allowing a password to be input;
finding the image set to be concealed if the assigned password matches the input password; and
displaying the found concealed image.

6. The method of claim 5, wherein the option for displaying information on the image set to be concealed is selected by selecting a concealed-image-view menu item.

7. The method of claim 1, wherein a user determines whether to set concealment of image information by directly setting an application marker included in an Exif header in an Exif file format.

8. The method of claim 1, wherein the digitized image is stored on a memory card.

9. The method of claim 1, further comprising:
determining whether the camera is in an image reproduction mode.

10. The method of claim 9, further comprising:
if the camera is not in an image reproduction mode, repeating the steps of
determining whether to conceal image information acquired during photographing of an image using the digital camera;
assigning a password to an image to be concealed;
setting concealment to the image to be concealed;
photographing an image;
digitizing the photographed image; and
storing the digitized image.

11. A method of concealing image information in a digital camera comprising:
assigning a password for setting image information concealment of the digital camera;
determining whether to conceal image information acquired during photographing of an image using the digital camera;
setting concealment to the image to be concealed;
photographing an image;
digitizing the photographed image;
storing the digitized image; and
not displaying the image set to be concealed when the camera is in a reproduction mode.

12. The method of claim 11, further comprising:
if image concealment is not set before an image is photographed,
determining whether to conceal the image, the determination occurring while the image is displayed in the reproduction mode after photographing;
setting concealment to the image set to be concealed; and
not displaying the image set to be concealed.

13. The method of claim 11, wherein a user determines whether to set concealment of image information by directly setting an application marker included in an Exif header in an Exif file format for a digital camera.

14. A method of concealing image information in a digital camera comprising:
assigning a password for setting image information concealment of the digital camera;
determining whether to conceal image information acquired during photographing of an image using the digital camera;
photographing an image;
digitizing the photographed image;
storing the digitized image in a concealment folder; and
not displaying the image stored in the concealment folder when the camera is in a reproduction mode.

15. The method of claim 14, further comprising:
if image concealment is not selected before an image is photographed,
determining whether to conceal the image, the determination occurring while the image is displayed in the reproduction mode after photographing;
moving the image set to be concealed to the concealment folder and storing the image in the concealment folder; and
not displaying the image stored in the concealment folder.

16. The method of claim 14, further comprising:
determining if an option for displaying information on the image chosen to be concealed has been selected;
allowing a password to be input;
searching the concealment folder and finding the image set to be concealed if the assigned password matches the input password; and
displaying the found concealed image.

17. The method of claim 15, further comprising:
determining if an option for displaying information on the image chosen to be concealed has been selected;
allowing a password to be input;
searching the concealment folder and finding the image set to be concealed if the assigned password matches the input password; and
displaying the found concealed image.

18. A digital camera capable of concealing image information comprising:
a main body having a lens portion and a display portion;
a shutter installed at one side of the main body;
a concealment setting input portion installed at one side of the main body that allows a user to determine whether to set concealment of image information by directly setting an application marker included in an Exif header in an Exif file format.

19. The digital camera of claim 18, further comprising:
a password input portion to input a password for concealment setting.

20. A digital camera capable of concealing image information comprising:
a main body having a lens portion and a display portion;
a shutter installed at one side of the main body;
a concealment setting input portion installed at one side of the main body to store an image set to be concealed in a concealment folder in a storage medium.

21. The digital camera of claim 20, further comprising:
a password input portion to input a password for concealment setting.

22. The digital camera of claim 20, wherein the storage medium is a memory card.
